(19) United States
(12) Patent Application Publication
(10) Pub. No.: US 2013/0173544 A1
(43) Pub. Date: Jul. 4, 2013

(54) MATERIALIZED QUERY TABLE JOURNALING IN A COMPUTER DATABASE SYSTEM

(71) Applicant: INTERNATIONAL BUSINESS MACHINES CORPORATION, Armonk, NY (US)

(72) Inventors: Eric L. Barsness, Pine Island, MN (US); John M. Santosuosso, Rochester, MN (US)

(73) Assignee: INTERNATIONAL BUSINESS MACHINES CORPORATION, Armonk, NY (US)

(21) Appl. No.: 13/773,223

(22) Filed: Feb. 21, 2013

Related U.S. Application Data
(63) Continuation of application No. 12/053,987, filed on Mar. 24, 2008.
Application No. 12/053,987 is a continuation of application No. 11/266,736, filed on Nov. 3, 2005, now abandoned.

(51) Int. Cl. G06F 17/30

(52) U.S. Cl. CPC G06F 17/30575
USPC 707/634

(57) ABSTRACT

An apparatus and method utilize MQTs in a more efficient manner in a high availability computer database to improve database performance and utility. In preferred embodiments, an MQT control file indicates whether journal entries for specific tables are to be propagated to replicated databases residing on other computer servers. In other embodiments, the MQT control file includes metrics that are used to control when the propagation is turned on and off.

### CROSS-REFERENCE TO PARENT APPLICATIONS

This patent application is a continuation of U.S. Ser. No. 12/053,987 filed Mar. 24, 2008, which is a continuation of U.S. Ser. No. 11/266,736 filed on Nov. 3, 2005. These two related patent application are incorporated herein by reference.

### BACKGROUND OF THE INVENTION

1. Technical Field

This invention generally relates to computer database systems, and more specifically relates to an apparatus and methods for materialized query table (MQT) journaling in a computer database.

2. Background Art

Database systems allow a computer to store a large amount of information in a way that allows a user to search for and retrieve specific information in the database. The information is typically stored in database tables. The tables contain columns and rows of data. The data in the table is related to or associated with other data in corresponding columns and rows. Relationships of the data are stored in indexes.

Retrieval of information from a database is typically done using queries. A database query typically includes one or more predicate expressions interconnected with logical operators. The database is searched for records that satisfy the query, and those records are returned as the query result. In database systems it is common for identical or closely related queries to be issued frequently. When a database contains very large amounts of data, certain queries against the database can take an unacceptably long time to execute.

It has become a common practice to maintain the results of often-repeated queries in database tables. By maintaining the results of queries, the costly join operations required to generate the results do not have to be performed every time the queries are issued. Rather, the database server responds to the queries by simply retrieving the pre-stored data. These stored results are sometimes referred to as a materialized view or materialized query tables (MQTs). The purpose for the MQT is to provide an aggregation of data that can satisfy many subsequent queries without repeating the full access to the database.

Computer database systems may also use high availability (HA) or database replication technology. High availability means availability despite planned outages for upgrades or unplanned outages caused by hardware or software failures. This technology achieves high data availability through fragmentation and replication of data across multiple servers. This technology typically relies on sending and receiving journal entries to maintain the data consistency of duplicate data across the servers.

HA systems allow MQTs to be duplicated on the target system as well as the base tables that the MQT is built over by sending journal entries from the source system to the target system. HA systems also allow the system administrator to not duplicate the MQTs at the target system. In this case, the target system generates the MQTs using the base table data in the normal fashion. Duplication of the MQTs at the target system using journal entries is advantageous, but to do so at times may over strain system resources.

Without a way to better utilize MQTs in HA systems, the computer industry will continue to suffer from inefficiency and poor database performance.

### DISCLOSURE OF INVENTION

In accordance with the preferred embodiments, an apparatus and method utilize MQTs in a more efficient manner in an HA computer database to improve database performance and utility. In preferred embodiments, an MQT control file indicates whether journal entries for specific tables are to be propagated to replicated databases residing on other computer servers. In other embodiments, the MQT control file includes metrics that are used to control when the propagation is turned on and off. This allows the system administrator to set up parameters that determine when propagation is used and when propagation is turned off. This allows the maximization of performance by saving system resources at certain times, such as when the system is busy with critical tasks as determined by the metrics set up by the system administrator.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is an computer system apparatus in accordance with the preferred embodiments;

FIG. 2 is a HA computer database system according to the preferred embodiments;

FIG. 3 is an example screen display for a prior art HA computer database system;

FIG. 4 is a screen display for a HA computer database system according to the prior art;

FIG. 5 is a screen display for a HA computer database system according to the prior art;

FIG. 6 is a screen display for a HA computer database system according to preferred embodiments;

FIG. 7 is a table that illustrates the contents of a MQT control file for a HA computer database system according to preferred embodiments;

FIG. 8 is an example flow diagram of a method according to preferred embodiments;

FIG. 9 is an example flow diagram of a method according to preferred embodiments; and

FIG. 10 is an example flow diagram of a method according to preferred embodiments.

### BEST MODE FOR CARRYING OUT THE INVENTION

1.0 Overview

The present invention relates to an apparatus and method to more efficiently utilize MQTs in a HA computer database to improve database performance and utility. For those not familiar with databases or queries, this Overview section provides background information that will help to understand the present invention.

Known Databases and Database Queries

There are many different types of databases known in the art. The most common is known as a relational database (RDB), which organizes data in tables that have rows that represent individual entries or records in the database, and columns that define what is stored in each entry or record.

In a broader view, data in a database system is stored in one or more data containers, where each container contains records, and the data within each record is organized into one or more fields. In relational database systems, the data containers are referred to as tables, the records are referred to as rows, and the fields are referred to as columns as described above. In object oriented databases, the data containers are referred to as object classes, the records are referred to as objects, and the fields are referred to as attributes. Other database architectures may use other terminology. While not intended to be limiting to relational databases, for the purpose of explanation, the examples and the terminology used herein shall be that typically associated with relational databases. Thus, the terms “table”, “row” and “column” shall be used herein to refer respectively to the data container, record, and field and similarly apply to the other types of database containers.

Retrieval of information from a database is typically done using queries. A database query is an expression that is evaluated by a database manager. The expression may contain one or more predicate expressions that are used to retrieve data from a database. For example, let's assume there is a database for a company that includes a table of employees, with columns in the table that represent the employee's name, address, phone number, gender, and salary. With data stored in this format, a query could be formulated that would retrieve the records for all female employees that have a salary greater than $40,000. Similarly, a query could be formulated that would retrieve the records for all employees that have a particular area code or telephone prefix. One popular way to define a query uses Structured Query Language (SQL). SQL defines a syntax for generating and processing queries that is independent of the actual structure and format of the database.

In database systems it is common for identical or closely related queries to be issued frequently. To respond to such queries, the database server typically has to perform numerous join operations because the database records contain the information that is required to respond to the queries. When a database contains very large amounts of data, certain queries against the database can take an unacceptably long time to execute. The cost of executing a query may be particularly significant when the query (which takes the form of a “SELECT” statement in the SQL database language) requires join operations among a large number of database tables.

Materialized Query Tables

It has become a common practice to maintain the results of often-repeated queries in database tables or some other persistent database object. By maintaining the results of queries, the costly join operations required to generate the results do not have to be performed every time the queries are issued. Rather, the database server responds to the queries by simply retrieving the pre-stored data. These stored results are sometimes referred to as materialized views or materialized query tables (MQT). An MQT initially may be a computed result of a given query. The purpose for the MQT is to provide an aggregation of data that can satisfy many subsequent queries without repeating the full access to the database.

Typically, the query table definition is in the form of a database query, herein referred to as a materialized query. The materialized query is processed and the results are stored as the MQT. The results can be in the form of rows, which may be rows from a single base table or rows created by joining rows in the base table. Materialized query tables eliminate the overhead associated with gathering and deriving the data every time a query is executed. Through a process known as query rewrite, a query can be optimized to recognize and use existing materialized query tables that could answer the query. Typically, the query rewrite optimization is transparent to the application submitting the query. That is, the rewrite operation happens automatically and does not require the application to know about the existence of materialized query tables, nor that a particular materialized query table has been substituted in the original query.

HA systems duplicate database tables from a source system to a target system using a journal management system that sends journal entries to keep the duplicate database up to date with the source database. Journal management is used to record the activity of objects on a computer system. The journal management system creates an object called a journal. The journal records the activities of the objects specified in the form of journal entries. The journal writes the journal entries in another object called a journal receiver. The journal receiver uses the journal entries to duplicate the objects on the target system.

MQTs are sometimes replicated along with their base tables onto another database server in HA computer database systems. HA systems also allow the system administrator to not duplicate the MQTs at the target system. In this case, the target system generates the MQTs using the base table data in the normal fashion. Duplication of the MQTs at the target system using journal entries is advantageous, but to do so at times may over strain system resources.

2.0 Detailed Description

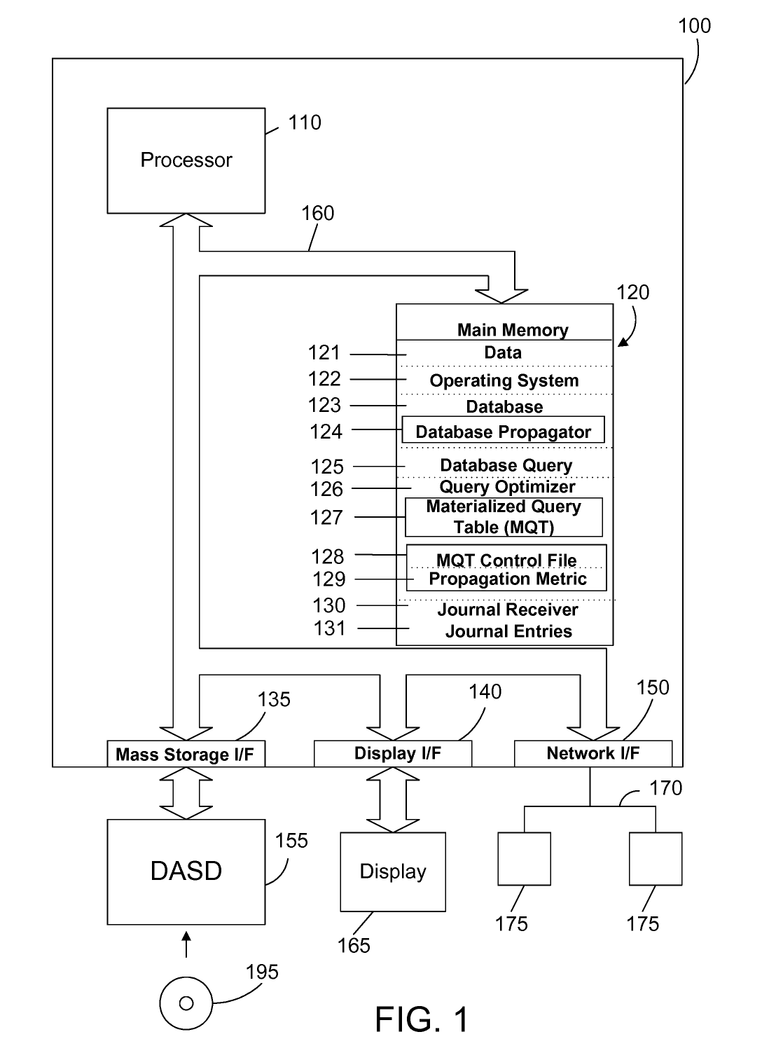

The preferred embodiments herein provide an apparatus and method to efficiently utilize an MQT in a HA computer database. The present invention allows the database manager to set up autonomical control parameters for the duplication of the MQT in the target computer system or computer server. Referring now to FIG. 1, a computer system 100 is one suitable implementation of an apparatus in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 135, a display interface 140, and a network interface 150. These system components are interconnected through the use of a system bus 160. Mass storage interface 135 is used to connect mass storage devices (such as a direct access storage device 155) to computer system 100. One specific type of direct access storage device 155 is a readable and writable CD RW drive, which may store data to and read data from a CD RW 195.

Main memory 120 in accordance with the preferred embodiments contains data 121, an operating system 122, and a database 123. Data 121 represents any data that serves as input to or output from any program in computer system 100. Operating system 122 is a multitasking operating system known in the industry as i5/OS; however, those skilled in the art will appreciate that the spirit and scope of the present invention is not limited to any one operating system. Database 123 is any suitable database, whether currently known or developed in the future. Database 123 includes one or more base tables (not shown). The memory 120 includes a database propagator 124 as described further below. In preferred embodiments, the database propagator is part of the database 123. Memory 120 further comprises one or more database queries 125, and a database query optimizer 126. Database query 125 is a query in a format compatible with the database 123 that allows information stored in the database 123 that satisfies the database query 125 to be retrieved. Database query optimizer 126 optimizes a query 125 and produces an access plan used by a database manager (not shown) in the database 123 to access the database. Database query optimizer 126 includes a Materialized Query Table (MQT) 127 that is updated by the query optimizer 126 in accordance with the preferred embodiments. The query optimizer 126 further includes an MQT control file 128 with one or more propagation metrics 129 as described further below. The computer system 100 also includes a journal receiver that stores journal entries 131 for use by the database and database propagator. The database uses the journal entries to update or rollback the data in the database. The propagator will use the journal entries to propagate the data to other target computers or servers as described further below.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, database 123, database query 125, the database query optimizer 126, and the journal receiver 130 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 135, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of signal bearing media used to actually carry out the distribution. Examples of suitable signal bearing media include: recordable type media such as floppy disks and CD RW (e.g., 195 of FIG. 1), and transmission type media such as digital and analog communications links. Note that the preferred signal bearing media is tangible.

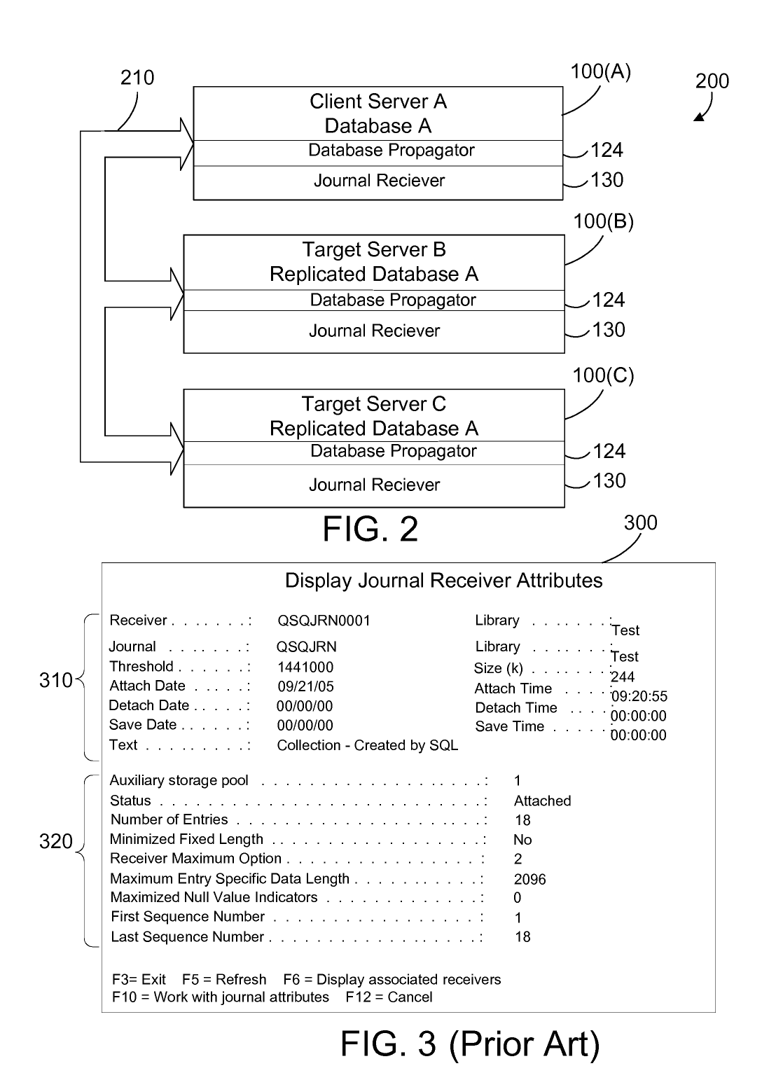

FIG. 2 illustrates an HA database system 200 according to preferred embodiments. The HA database system 200 has a first computer server that is referred to as client server 100(A). The client server 100(A) communicates with one or more target systems illustrated as target server 100(B) and target server 100(C). The client server 100(A) and the target computers 100(B), 100(C) are interconnected over a computer network 210. Each of the computer servers, both client and target computers could comprise a computer system 100 as shown in FIG. 1. Of course it is apparent to those skilled in the art that there could be additional client servers and target serves connected the computer network 210.

Again referring to FIG. 2, in the illustrated HA database system 200 each of the client and target servers 100(A), 100(B), 100(C) include a database propagator 124. The database propagator 124 works in conjunction with the database to propagate journal entries to target servers to replicate the database at the target locations. Database propagation is known in the prior art and the described database propagator 124 works in a similar fashion but with the additional features described herein. Each of the client and target servers 100(A), 100(B), 100(C) in the HA database system 200 further include a journal receiver 130. Journal receivers are also known in the prior art and are used to store and process journal entries in the client server 100A and target servers 100(B), 100(C). The database uses the journal entries to update or rollback the data in the database. The features of journal receiver 130 are similar to the prior art except for the additional features described further below.

FIG. 3 represents a display 300 of a computer operating a HA database system according to the prior art. The display 300 shows example data that is used for illustration and to contrast with preferred embodiments described below. The display 300 represents the HA computer system 100(A) displaying for the system administrator the journal receiver attributes for a journal receiver QSQJRN0001 associated with the journal QSQJRN. The receiver attributes includes a variety of information, some of which is only explained here briefly as it is known in the art and is not important to the present invention. The upper block of receiver attributes 310 includes time information for when the receiver was attached and detached to the journal. The upper block of the receiver attributes display 310 also shows when the receiver was last saved, the size and the associated library, and a text line. The lower block of receiver attributes includes the auxiliary storage pool, status, number of entries, minimized fixed length, receiver maximum option, maximum entry specific data length, maximized null value indicators, first sequence number and last sequence number.

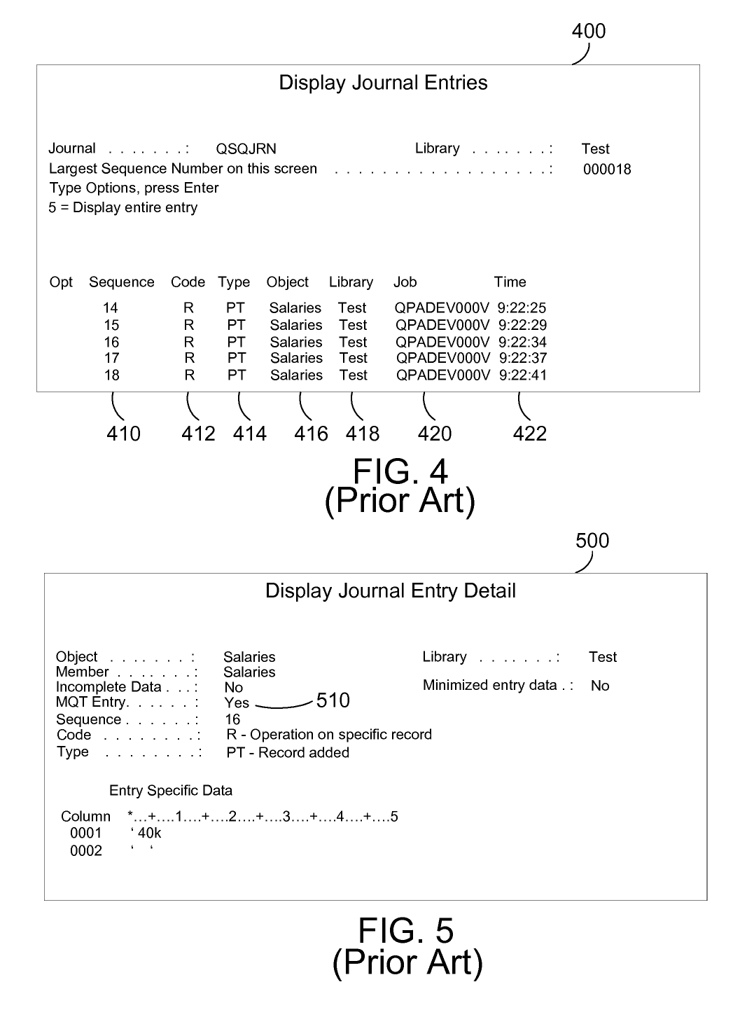

FIG. 4 illustrates another display 400 of a computer operating a HA database system according to the prior art. In FIG. 4, the display 400 represents the HA computer system 100(A) displaying for the system administrator the journal entries residing in the journal receiver QSQJRN shown in FIG. 3 at a the moment of time the display was initiated by the system administrator. The display 400 shows journal entries residing in the journal receiver listed by sequence number 410. The display 400 includes five journal entries listed as sequence number 14 through sequence number 18. In addition to the sequence number 410 for each journal entry, the display 400 includes the code 412, the type of entry 414, the object of the entry 416, the library 418 the entry resides in, the job 420 that initiated the journal entry, and the time 422 the journal entry was entered into the journal receiver. In the illustrated example, the code “R” means the journal entry is for a record level operation. The journal type “PT” means the journal entry is a put (insert) operation.

FIG. 5 illustrates another display 500 of a computer screen operating a HA database system according to the prior art. In FIG. 5, the display 500 represents the HA computer system 100(A) displaying for the system administrator a single journal entry in the journal receiver QSQJRN shown in FIG. 3. The display 500 includes the contents of the journal entry shown as sequence number 16 in FIG. 4. Of particular interest to the present invention is the MQT Entry 510 that indicates whether the journal entry is for an MQT. This entry is used by the present invention in conjunction with the added entries in the journal receiver described below and the MQT control file shown in FIG. 7 below.

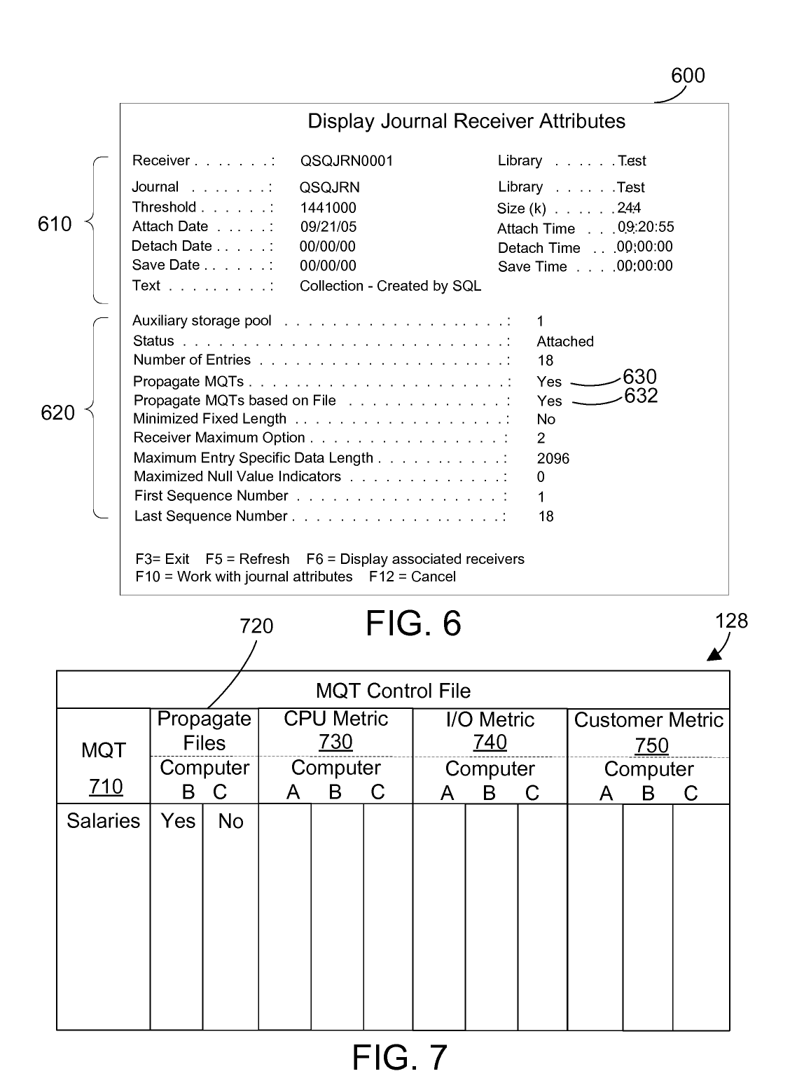

FIG. 6 illustrates a display 600 of a computer screen operating a HA database system according to the preferred embodiments. The display 600 is similar to the prior art display shown in FIG. 3. The display 600 shows the HA computer system displaying for the system administrator the journal receiver attributes for a journal receiver QSQJRN0001 associated with the journal QSQJRN. The illustrated receiver attributes includes the same information which was described above with respect to FIG. 3 and also includes further information according to the preferred embodiments. The upper block of receiver attributes 610 includes the same information described above with reference to 310 in FIG. 3. The lower block of receiver attributes 620 includes the information described above in addition to MQT propagation attributes 630, 632 according to preferred embodiments.

Again referring to FIG. 6, the MQT propagation attributes 630,632 are added to the prior art receiver attributes to allow the receiver to autonomically control the propagation of the MQT in the target computer system or computer server. These attributes can be modified by the system administrator using this display screen or with a similar display screen called “Modify Journal Receiver Attributes.” The first propagation attribute 630 indicates to allow the propagation of all MQTs from the client server 100(A) to one or more target computers 100(B), 100(C) as shown in FIG. 2. The second propagation attribute 632 indicates whether to propagate MQTs based on a file. This attribute means that MQT's will only be propagated if the propagation files flag 720 for the corresponding MQT is set as described below with reference to FIG. 7. In the preferred embodiments, a task of the database propagator software examines the status of the propagate MQTs attribute 630 and the propagate MQTs based on file attribute 632. If these attributes are both ‘yes”, then each table in the MQT control file 128 is processed according to any metrics setup in the MQT control file 128 to turn on or off propagation as described below.

FIG. 7 shows an information table that represents an MQT control file 128 according to preferred embodiments. The MQT control file 128 is preferably stored by the database propagator 124. The MQT control file 128 includes data entries for each MQT 710 listed in the MQT control file 128. In the illustrated example of FIG. 7, the data for each MQT 710 is a row of parameters in the MQT control file 128. The first parameter in the MQT control file 128 is the propagate files flag 720. This flag indicates yes or no as to whether the system should propagate or journal files to the target system. In the preferred embodiments, there is a propagate files flag 720 in the MQT control file for each target system. In the illustrated example of FIG. 2, there is a target computer B and a target computer C so there are corresponding propagate file flags 720 in the MQT control file 128 as shown for computer B and computer C.

Again referring to FIG. 7, the MQT control file parameters also include a number of metrics 730, 740, 750 that are preset by a system administrator to control the propagation of the MQT in the target computer system or computer server. The illustrated metrics are not exhaustive of metrics that could be incorporated within the scope of the claimed invention. The first metric is the CPU metric 730. This metric could indicate a CPU utilization percent or some other CPU parameter for each of the client (A) and target computers (B, C). The next metric is the I/O metric 740. This metric examines the utilization of some I/O port or task that creates a limiting factor on the overall performance of the database system. The next metric is a customer defined metric 750. This metric allows the end user or customer to define a metric of particular interest to customize the performance for a particular user's system requirements.

In the preferred embodiments, a task of the database propagator 124 in the HA database system periodically sets the propagate files flag 720 based on the metrics 730, 740, 750. A computer task may use any known or future techniques to examine the performance of the HA system or any computer within the HA system using the metrics in the MQT control file and based on those metrics compared to the system performance then autonomically set the propagate files flag 720. After the propagate files flag is set, the database propagator 124 on the client server 100(A) must send a synchronization (sync) message to the database propagator on target servers 100(B), 100(C) to maintain data integrity. If the propagate files is turned off, the target servers must then begin to use base table information to create MQTs since the MQTs are no longer being propagated. If the sync message indicates MQTs are being propagated, the target servers can begin to use the propagated data to maintain the MQTs.

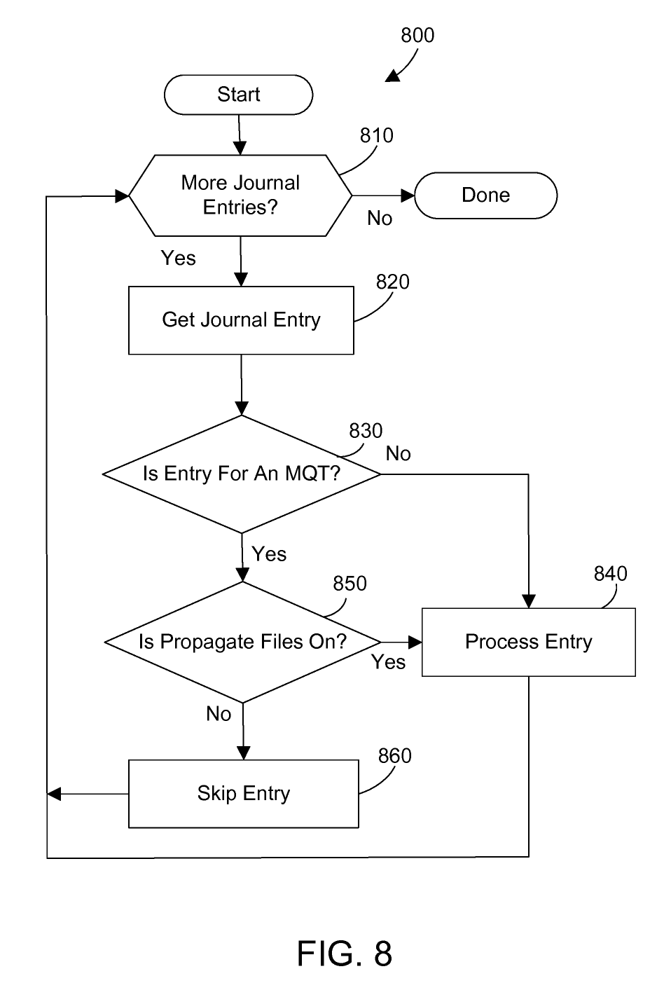

Referring now to FIG. 8, a flow diagram shows a method 800 for efficiently using an MQT in a HA computer database system according to a preferred embodiment. The method 800 is presented as a series of steps performed by a computer software program described above as a database propagator 130. The illustrated method is run periodically or otherwise initiated to process outstanding journal entries on the source computer system. The database propagator 130 determines if there are more journal entries to process (step 810). If there are journal entries to process (step 810=yes) then the database propagator gets a journal entry (step 820). If the journal entry does not correspond to an MQT (step 830=no) then the database propagator proceeds to process the entry (step 840). In processing the entry, the database propagator communicates with the database propagator operating on the target system to replicate the database on the target computer system. If the journal entry corresponds to an MQT (step 830=yes) then the database propagator proceeds to determine if propagate files is turned on for the corresponding MQT by checking the MQT control file (step 850). If the propagate files is turned on for the current MQT (step 850=yes) then the database propagator proceeds to process the journal entry (step 840). If the propagate files is turned off for the MQT of the current journal entry (step 850=no) then the database propagator skips the journal entry (step 860) and returns to step 810. If there is no more journal entries (step 810=no) then method 800 is done.

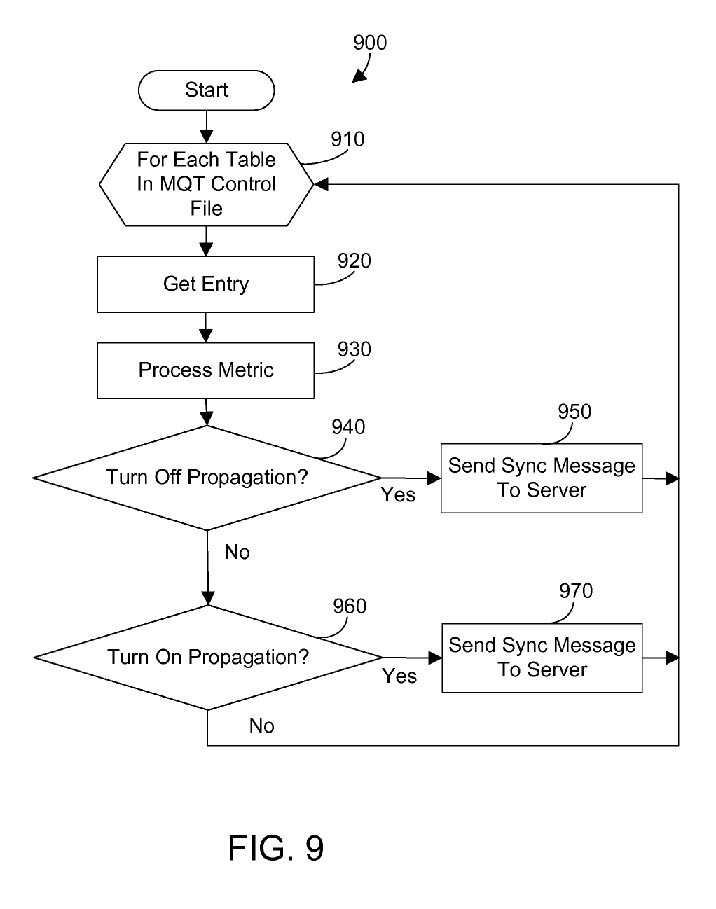

Referring now to FIG. 9, a flow diagram shows a method 900 for monitoring propagation metrics on a source computer system and sending sync messages to a target computer system according to preferred embodiments. The steps of method 900 are executed periodically such as by a timed interrupt on the source computer when the propagate MQTs based on file flag 632 is set to “yes” as described above. Method 900 is presented as a series of steps performed by a computer software program described above as a database propagator 130. The described steps could also be viewed as being performed by a database engine that performs database operations where the database propagator is part of the database engine. The method 900 executes a sequence of steps for each table in the MQT config file (step 910). The method 900 gets an entry from the MQT config file (step 920). The metric is processed depending on the type of metric to determine whether the source computer should turn on propagation or turn off propagation (step 930). If the processing of the metric determines that propagation should be turned off (step 940=yes) then a sync message is sent to the server to be forwarded to the target computer (step 950) and the method returns for the next MQT in the MQT config file (step 910). If the processing of the metric determines that propagation should be turned on (step 960=yes) then a sync message is sent to the server to be forwarded to the target computer (step 970) and the method returns for the next MQT in the MQT config file (step 910). When each MQT in the MQT config file has been processed (step 910) then the method is done.

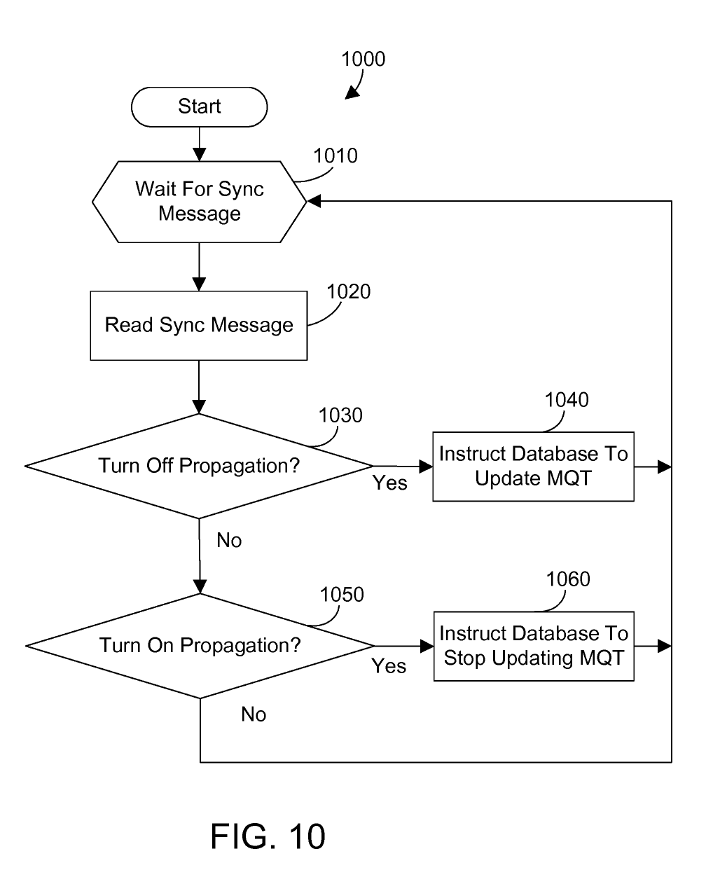

Referring now to FIG. 10, a flow diagram shows a method 1000 for monitoring sync messages on a target computer system to instruct a database system when to update MQTs according to preferred embodiments. Method 1000 is presented as a series of steps performed by a computer software program described above as a database propagator 130 and executing on the target computer system. The method 1000 executes a sequence of steps each time a sync message is received (step 1010). The method 1000 gets reads the sync message received (step 1020). If the sync messages indicates to turn off propagation (step 1030=yes) then the database is instructed to update the corresponding MQTs using base tables in the traditional manner (step 1040) and the method returns to wait for the next sync message (step 1010). If the sync messages indicates to turn on propagation (step 1050=yes) then the database is instructed to stop updating the corresponding MQTs using the base tables (step 1060) and the method returns for the next sync message (step 1010). The method would typically run in a continuous cycle as described each time a sync message is received (step 1010).

The present invention as described with reference to the preferred embodiments provides significant improvements over the prior art. The described apparatus and method provide an efficient propagation of an MQT in a HA computer database. The present invention provides a way to improve system performance, and reduce excessive delays in database accesses in HA computer database systems.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

1. A method for a utilizing a materialized query table (MQT) in a database journal system, the method comprising the steps of:
(A) providing a journal receiver that maintains data consistency of duplicate data across multiple servers using journal entries, wherein the journal receiver uses journal entries to duplicate materialized query tables (MQTs) on a target system depending on journal receiver attributes with at least one journal receiver attributes flag that indicates whether to propagate MQTs based on an MQT control file that comprises:
a propagate files flag for a plurality of target computers corresponding to each listed MQT in the MQT control file to indicate whether a journal entry should be propagated to a corresponding target computer for the listed MQT; and
one or more metrics for the plurality of target computers to indicate when propagation should be turned on and off for any of the plurality of MQTs indicated by the corresponding propagate files flag;
(B) for each entry into the journal receiver, determining if the entry is for an MQT;
(C) processing the entry if it is not for an MQT;
(D) processing the entry if it is for an MQT and the propagate files flag in the MQT control file is set; and
(E) skipping the entry if it is for an MQT and the propagate files flag in the MQT control file is not set.

2. The method of claim 1 wherein the one or more metrics comprise a CPU metric and an I/O metric set up by a system administrator.

3. The method of claim 2 wherein the one or more metrics further comprise a customer defined metric set up by a system administrator.

4. The method of claim 2 further comprising the steps of:
processing the one or more metrics for each entry in the MQT control file;
turning off propagation when the processing of the metric indicates the computer system is not meeting the one or more metrics;
turning on propagation when the processing of the metric indicates the computer system is meeting the one or more metrics; and
sending a sync message to a corresponding target server to turn on or off propagation.

4. The method of claim 3 further comprising the step of processing sync messages on a target server comprising the steps of:
periodically reading sync messages;
instructing the database to update MQTs with journal entries if propagation is turned on in the sync message; and
instructing the database to stop updating MQTs with journal entries if propagation is turned off in the sync message.
